(19) United States
(12) Patent Application Publication
(10) Pub. No.: US 2009/0152256 A1
(43) Pub. Date: Jun. 18, 2009

(54) METHOD FOR MANUFACTURING A STAMPED/HEATED PART FROM A STEEL SHEET PLATED WITH ALUMINUM ALLOY

(75) Inventors: Alan Seid, Dublin, OH (US); Masayuki Narita, Dublin, OH (US)

Correspondence Address: BROUSE MCDOWELL LPA, 388 SOUTH MAIN STREET, SUITE 500, AKRON, OH, 44311, US

(73) Assignee: Honda Motor Co., Ltd., Tokyo (JP)

(21) Appl. No.: 11/954,874

(22) Filed: Dec. 12, 2007

(51) Int. Cl. B21D 35/00; B21J 1/06; B23P 23/00; H05B 1/00

(52) U.S. Cl. 219/149; 219/162; 29/33 R; 29/592; 72/364

(57) ABSTRACT

A method and related apparatus are disclosed for heating and stamping a processed part. A sheet of high-tensile steel is provided as a work part. The sheet is plated with a high-temperature-resistant material to improve formability. The temperature-resistant material can include oxidized aluminum or a high-temperature-resistant alloy of aluminum and/or zinc and/or steel. An electrical current is applied to the work part to provide heating to the work part through resistance heating. The plated sheet can be stamped while heating to form a stamped work part. The work part is quenched through cooling to increase metallurgical strength.

### I. BACKGROUND OF THE INVENTION

A. Field of Invention

This invention generally relates to heating and stamping metal parts. The invention has particular applicability to providing a stamped part having reduced weight and increased strength.

B. Description of the Related Art

The present invention provides a method and apparatus for manufacturing, a stamped metal part that overcomes the problems associated with previous methods and apparatuses which require large scale heating furnaces that lack energy efficiency and have a large environmental impact.

### II. SUMMARY OF THE INVENTION

Some embodiments of the present invention relate to an apparatus for simultaneously heating and stamping a processed part. A resistance heating assembly applies an electrical current to a work part. The work part is a sheet of high-tensile steel having a heat-resistant plating to improve formability. A stamping assembly stamps the plated sheet simultaneously during the resistance heating process to form a stamped work part. A quenching bath quenches the work part through quick cooling to increase strength.

Other embodiments of the invention relate to a method of simultaneously heating and stamping a processed part. A sheet of high-tensile steel is provided as a work part. The steel sheet is plated with a high-temperature-resistant plating material to improve formability. An electrical current is applied to the work part to provide heating to the work part through resistance heating. The plated sheet is stamped simultaneously while heating to form a stamped work part. The work part is quenched through quick cooling to increase metallurgical strength.

Still other embodiments of the invention relate to an apparatus for simultaneously heating and stamping a processed part including means for applying an electrical current to a work part to provide heating to the work part through resistance heating. The work part comprises a sheet of high-tensile steel plated with a high-temperature-resistant plating material to improve formability. Means are provided for stamping the plated sheet simultaneously while heating to form a stamped work part. Means are additionally provided for quenching the work part through quick cooling to increase metallurgical strength.

Other benefits and advantages will become apparent to those skilled in the art to which it pertains upon reading and understanding the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a side-sectional view depicting a heating and stamping system in accordance with an embodiment of the present invention;

FIG. 2 is a plan schematic view showing a resistance heating system in accordance with an embodiment of the present invention;

FIG. 3 is a side-sectional view illustrating a sheet of steel protected with a heat-resistant plating in accordance with an embodiment of the present invention; and

FIG. 4 is a flow chart depicting steps in a method of manufacturing in accordance with an embodiment of the present invention.

### IV. DETAILED DESCRIPTION OF THE INVENTION

The present invention generally relates to systems and methods for heating and stamping a metal part. In particular, the present invention relates to systems and methods for simultaneously heating and stamping a metal part having a heat-resistant plating that improves formability and allows rapid heating without melting or dissipation of the plating layer.

The present invention overcomes problems associated with efficiency in material and energy consumption in the manufacturing industries. Specifically, the present invention has particular applicability to the automotive industry by producing high-strength, lightweight manufactured parts that reduce the burden on the environment and improve fuel economy while also improving compliance with regulations for crash safety.

The present invention utilizes an electrical resistance heating process of a steel sheet rather than using a conventional large-scale furnace that requires a large space and consumes much energy, having a considerable environmental impact. Also, the present heat-resistant plating improves formability of the steel sheet and thereby enables rapid heating without melting or dissipating under the heat. A stamping process is performed simultaneously with the heating process, and is followed by quick cooling in a quenching process which metallurgical increases the strength of the part.

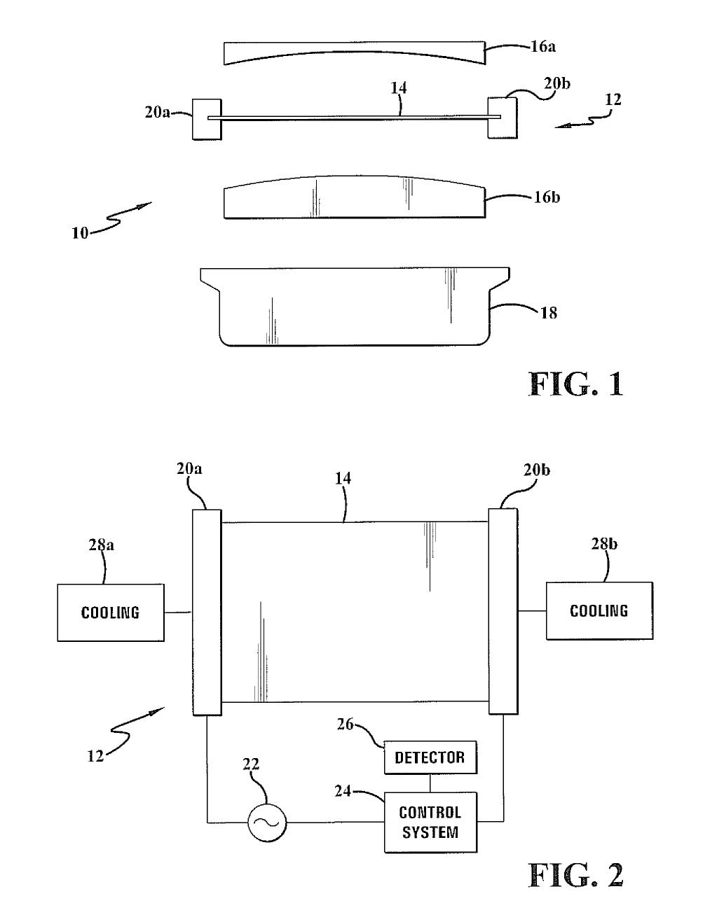

Reference is now made to the drawings wherein the showings are for purposes of illustrating embodiments of the invention only and not for purposes of limiting the same, and where it is to be understood that like reference numerals refer to like components. FIG. 1 illustrates an apparatus 10 for simultaneously heating and stamping a processed part. A resistance heating assembly 12 applies an electrical current to a work part 14. The work part 14 is formed of a sheet of high-tensile steel having a heat-resistant plating to improve formability. A stamping assembly 16a, 16b is provided that stamps the plated sheet 14 simultaneously during resistance heating to form a stamped work part. A quenching bath 18 quickly cools the work part 14 to increase the mechanical strength of the work part 14.

As shown in FIGS. 1 and 2, the resistance heating assembly 12 includes a first end clamp 20a and a second end clamp 20b. These end clamps 20a, 20b are secured to opposite ends of the work part 14 and supply the electrical current to the work part 14 for resistance heating. In using the techniques of resistance heating (as are well known in the art) the work part 14 is in an electrical circuit with an electrical generator 22. An electrical current is passed between the end clamps 20a, 20b and thereby through the work part 14. In this way, electrical energy is imparted to the work part 14 in the form of heat. Heat energy is thereby applied directly to the work part 14 in a precise, efficient manner, in contrast to typical conventional heating in which the entire volume of a furnace is heated to heat a work part.

As shown in FIG. 1, the stamping assembly includes a first die 16a and a second die 16b that reciprocally come together over the work part 14 to apply a large force. The first and second dies 16a, 16b have respective mating surfaces in the shape of the final product. The dies 16a, 16b can be driven together by, for example, a hydraulic assembly (not shown) as is commonly known in the art. As contemplated with the present invention, the work part 14 is inserted into the end clamps 20a, 20b and the electricity is applied to the work part 14 to rapidly raise its temperature to the desired level. Simultaneously, the stamping dies 16a, 16b come together over the work part 14 to form the final stamped product.

As shown particularly in FIG. 2, the resistance heating assembly 12 preferably includes a heating control system 24 that regulates the flow of electrical current to the work part 14 in order to control the temperature of the work part 14. According to some embodiments, the heating control system 24 can impart a desired temperature to the work part 14 by applying a predetermined electrical current for a predetermined interval of time, where the resistance and heat capacity of the work part 14 is also predetermined. In this way, a desired stamping temperature can be rapidly achieved by applying a large current to the work part 14 for a short interval.

A greater level of accuracy and/or precision can be obtained with the resistance heating assembly 12 by using a thermal detector 26 that detects a heating condition in the work part 14 and generates feedback to the heating control system 24. The thermal detector 26 can be a radiative sensor, displaced from the surface of the work part 14, that measures heat radiation coming from the work part 14. Alternatively, it can be a temperature sensor in direct contact with the work part 14. The thermal detector 26 can be a single sensor adapted to measure temperature in one selected area, or it can be either a linear or a surface sensor array that respectively measures at least a portion of the length or the surface of the work part 14, in order to collect a number of data points indicative of temperature. In any event, the thermal detector 26 monitors temperature in order to provide quick and even heating to the work part 14.

In order to preclude localized heating in the vicinity of the first and second end clamps 20a, 20b, one or both of the first and second end clamps 20a, 20b can include a cooling component 28a, 28b to reduce temperature increases in the respective clamp. These localized temperature increases would otherwise cause uneven heating in the work part 14 and could affect its formability or the metallurgical properties of the finished product. This cooling component 28a, 28b can be a fluid jacket that surrounds and supplies cooling fluid to the end clamps 20a, 20h. The cooling fluid can come from the quench bath 18 or from any other source.

The controlled application of heat and the temperature monitoring of the work part allows a predetermined high temperature to be rapidly applied by the heating assembly 12. In this way, the steel sheet of the work part reaches a temperature resulting in the high-strength martensitic phase of the steel sheet. The martensitic metallurgical state of the work part 14 that is achieved at the higher temperature is preserved and maintained by rapidly quenching the work part 14.

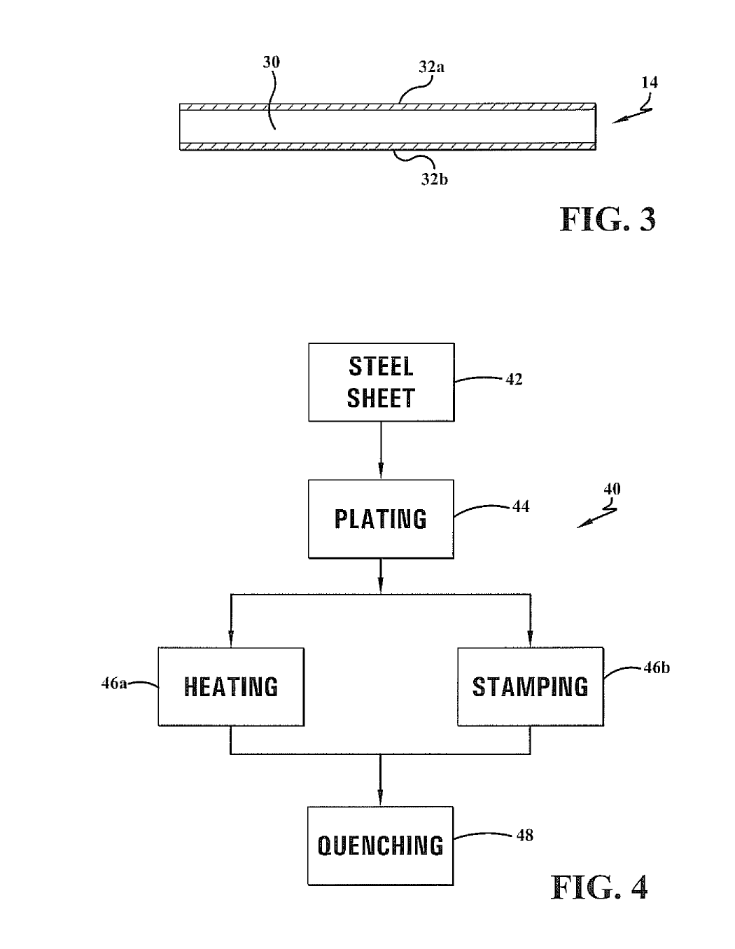

As shown especially in FIG. 3, the work part 14 is formed of a steel sheet 30 that is plated on the top and bottom surfaces with heat-resistant plating layers 32a, 32b. The heat-resistant plating layers 32a, 32b have a higher melting point temperature that allows rapid heating of the work part to the martensitic phase, since the common aluminum plating can melt or dissipate at these temperatures.

The heat-resistant plating layers 32a, 32b can include an oxidized aluminum layer, which has a higher melting point than aluminum metal, and thereby resists melting or dissipation at the operating temperatures suitable for steel hardening. The oxidized layer can be formed by plating aluminum to the steel sheet 30 and then oxidizing the aluminum layers 32a, 32b through a chemical process. The oxidized aluminum layers 32a, 32b maintain the formability of the sheet at the desired temperatures, thereby allowing the stamping operation to produce a metal part having the desired metallurgical properties.

Melting and dissipation of the plated layers can also be controlled by a process of slowly heating an aluminum plated work part 14 until an alloy layer forms along the boundary of the steel plate substrate. This alloy has a higher melting point than non-alloy aluminum. However, considerable heating time is required to reach this alloy phase, which thus adversely affects productivity and efficiency. The heat-resistant plating layers 32a, 32b can be formed of an aluminum alloy having a higher melting point than non-alloy aluminum, so as to resist melting and dissipation at operating temperatures suitable for steel hardening. The aluminum alloy can be an aluminum/steel alloy, a zinc/steel alloy or an alloy of aluminum and zinc, with or without steel in the alloy matrix. The alloy layers 32a, 32b maintain the formability of the sheet at the desired temperatures, so as to allow a stamping operation that produces a metal part having suitable metallurgical properties.

FIG. 4 is a flow chart depicting a method 40 of simultaneously heating and stamping a processed part in accordance with the present invention. A step 42 is performed of providing a sheet of high-tensile steel as a work part. In this embodiment, the high-tensile steel material is selected to produce a lightweight but high-strength part for a motor vehicle, so as to comply with increasingly high standards for both fuel efficiency and crash safety.

A step 44 is performed of plating the sheet with a high-temperature-resistant plating material to improve formability. This step 44 can include a step of plating with aluminum onto the sheet steel, and can further include oxidizing the aluminum through a chemical process. The oxidation produces an alumina layer that has a higher melting point than aluminum metal, which thereby resists melting or dissipation at the operating temperatures suitable for steel hardening.

Alternatively, the step 44 of plating can include plating the steel sheet so as to form an alloy layer having a higher melting point than non-alloy aluminum. Thus, the plating layer resists melting and dissipation at operating temperatures suitable for steel hardening. The aluminum alloy can be an aluminum/steel alloy, a zinc/steel alloy or an alloy of aluminum and zinc, with or without steel in the alloy matrix.

A step 46a is performed of applying an electrical current to the work part to heat the work part through resistance heating. A step 46b is simultaneously performed of stamping the plated sheet while heating so as to form a stamped work part. One of skill in the art will recognize that the steps of heating and stamping can temporally vary relative to each other. For example, the step of heating 46a can begin prior to the step of stamping 46b, and can overlap in time with the step of stamping 46b, or can even occur entirely prior to the step of stamping 46b. First and second stamping dies are brought together across the work part while it is being heated, so that the work part reaches its desired temperature just as the dies are coming together, thus saving time and improving energy efficiency. A step 48 of quenching the work part is performed so as to provide quick cooling to the stamped part and thereby increase its metallurgical strength. In this way, a finished part is formed that is lightweight and strong, and is manufactured quickly and with a high level of energy efficiency.

The step 46a of applying an electrical current includes applying an electrical current to opposite ends of the work part, so as to convert the electrical energy into heat within the steel work part. Uneven heating may occur since the temperature of the work part may be higher at the ends where the current is applied. Therefore, an intermediate step can be performed that comprises slowing or stopping heating at the opposite ends that would cause uneven heating in the work part. This is can be done by applying a cooling material such as a fluid to the apparatus at each end of the work part.

Temperature variations over the work part can be additionally or further regulated and controlled by detecting a heating condition in the work part and generating feedback so as to selectively vary the current flow. The heating condition can be detected by measuring heat radiation coming from the work part. Alternatively, temperature can be measured from direct contact with the work part. The thermal state of the work part can be measured in at selected areas along the length and/or the surface of the work part, so as to collect a number of data points indicative of temperature.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

I/We claim:

1. An apparatus for simultaneously heating and stamping a processed part comprising:
a resistance heating assembly that applies an electrical current to a work part comprising a sheet of high-tensile steel having a heat-resistant plating to improve formability;
a stamping assembly that stamps the plated sheet simultaneously during resistance heating to form a stamped work part; and
a quenching bath that quenches the work part through quick cooling to increase strength.

2. The apparatus of claim 1, wherein the resistance heating assembly further comprises a heating control system that regulates the electrical current to the work part in order to control the temperature of the work, part.

3. The apparatus of claim 2, wherein the resistance heating assembly further comprises a thermal detector that detects a heating condition in the work part and generates feedback to the heating control system in order to provide quick and even heating to the work part.

4. The apparatus of claim 1, wherein the resistance heating assembly comprises first and second end clamps, secured to opposite ends of the work part, for supplying the electrical current to the work part for resistance heating.

5. The apparatus of claim 4, wherein at least one of the first and second clamps comprise a cooling component to reduce temperature increases in the respective clamp that would cause uneven heating in the work part.

6. The apparatus of claim 1, wherein the heat-resistant plating on the work part comprises an oxidized aluminum layer that resists dissipation at operating temperatures suitable for steel hardening.

7. The apparatus of claim 1, wherein the heat-resistant plating on the work part comprises an alloy that resists dissipation at operating temperatures suitable for steel hardening.

8. The apparatus of claim 1, wherein the alloy comprises at least two of aluminum, zinc, and steel.

9. A method of simultaneously heating and stamping a processed part comprising:
providing a sheet of high-tensile steel as a work part;
plating the sheet with a high-temperature-resistant plating material to improve formability;
applying an electrical current to the work part to provide heating to the work part through resistance heating;
stamping the plated sheet to form a stamped work part; and
quenching the work part through quick cooling to increase metallurgical strength.

10. The method of claim 9, wherein at least a portion of the step of applying an electrical current coincides with the step of stamping.

11. The method of claim 9, wherein the step of applying an electrical current comprises regulating the electrical current to the work part in order to control the temperature of the work part.

12. The method of claim 11, wherein the step of regulating the electric current comprises detecting a heating condition in the work part and generating.

13. The method of claim 9, wherein the step of applying an electrical current comprises applying electrical current to opposite ends of the work part.

14. The method of claim 13, wherein the step of applying electrical current to opposite ends of the work part further comprises slowing or stopping temperature increases at the opposite ends that would cause uneven heating in the work part.

15. The method of claim 9, wherein the step of plating the sheet with a high-temperature-resistant plating material comprises plating the sheet with an aluminum layer and oxidizing the aluminum layer to form an oxidized layer that resists dissipation at operating temperatures suitable for steel hardening.

16. The method of claim 9, wherein the step of plating the sheet with a high-temperature-resistant plating comprises plating the sheet with an alloy that resists dissipation at operating temperatures suitable for steel hardening.

17. The method of claim 16, wherein the plating with an alloy comprises plating with an alloy comprising at least two of aluminum, zinc, and steel.

18. An apparatus for simultaneously heating and stamping a processed part comprising:
means for applying an electrical current to a work part to provide heating to the work part through resistance heating, wherein the work part comprises a sheet of high-tensile steel plated with a high-temperature-resistant material to improve formability;
means for stamping the plated sheet while heating to form a stamped work part; and
means for quenching the work part through cooling, wherein cooling increases metallurgical strength.

19. The apparatus claim 18, further comprising means for regulating the electrical current to the work part in order to control the temperature of the work part.

20. The apparatus of claim 18, further comprising means for detecting a heating condition in the work part and generating feedback to regulate the electrical current and provide quick and even heating to the work part.
